(19) United States
(12) Patent Application Publication
(10) Pub. No.: US 2007/0199385 A1
(43) Pub. Date: Aug. 30, 2007

(54) Capacitor electrode formed on surface of integrated circuit chip

(75) Inventors: David O'Brien, Norcross, GA (US); Liang You, Alpharetta, GA (US)

Correspondence Address: JOHN S. PRATT, ESQ;KILPATRICK STOCKTON, LLP, 1100 PEACHTREE STREET, ATLANTA, GA, 30309, US

(73) Assignee: CardioMEMS, Inc., Atlanta, GA (US)

(21) Appl. No.: 11/601,597

(22) Filed: Nov. 17, 2006

Related U.S. Application Data
(60) Provisional application No. 60/737,904, filed on Nov. 18, 2005.

(51) Int. Cl. G01L 9/12

(52) U.S. Cl. 73/718

(57) ABSTRACT

A sensor has a sensor housing defining a cavity therein. A first wall partially defining the cavity is deflectable under a physiologically relevant range of pressures. An integrated circuit chip bearing electronics is fixedly mounted within the cavity. A capacitor comprises first and second capacitor plates in generally parallel, spaced-apart relation. The first capacitor plate is physically coupled to the deflectable wall so as to move as the wall deflects, and the second capacitor plate is carried by the chip. The second capacitor plate is in electrical communication with the input pad of the chip.

### TECHNICAL FIELD

The present invention relates generally to pressure sensors, and relates more specifically to an absolute pressure sensor formed on the surface of an integrated circuit chip.

### BACKGROUND OF THE INVENTION

Over the past 20 years, advances in the field of microelectronics have enabled the realization of microelectromechanical systems (MEMS) and corresponding batch fabrication techniques. These developments have allowed the creation of sensors and actuators with micrometer-scale features. With the advent of this capability, previously implausible applications for sensors and actuators are now significantly closer to commercial realization.

In parallel, much work has been done in the development of pressure sensors. In particular, absolute pressure sensors, in which the pressure external to the sensor is read with respect to an internal pressure reference, are of interest. The internal pressure reference is a sealed volume within the sensor that typically contains a number of moles of gas (the number can also be zero, i.e. the pressure reference can be a vacuum, which can be of interest to reduce temperature sensitivity of the pressure reference as known in the art). The external pressure is then read relative to this constant and known internal pressure reference, resulting in measurement of the external absolute pressure. For stability of the pressure reference, and assuming the temperature and volume of the reference are invariant or substantially invariant, it is desirable that the number of moles of fluid inside the reference does not change. One method to approach this condition is for the reference volume to be hermetic.

The term hermetic is generally defined as meaning “being airtight or impervious to air.” In reality, however, all materials are, to a greater or lesser extent, permeable, and hence specifications must define acceptable levels of hermeticity. An acceptable level of hermeticity is therefore a rate of fluid ingress or egress that changes the pressure in the internal reference volume (a.k.a. pressure chamber) by an amount preferably less than 10 percent of the external pressure being sensed, more preferably less than 5 percent, and most preferably less than 1 percent over the accumulated time over which the measurements will be taken. In many biological applications, an acceptable pressure change in the pressure chamber is on the order of 1.5 mm Hg/year.

The pressure reference is typically interfaced with a sensing means that can sense deflections of boundaries of the pressure reference when the pressure external to the reference changes. A typical example would be a pressure reference that is bounded on at least one side with a deflectable diaphragm or plate. A suitable technique such as a piezoresistive or capacitance measurement can be used to measure the deflection of the diaphragm or plate. If the deflection of the diaphragm or plate is sufficiently small, the volume change of the pressure reference does not substantially offset the pressure in the pressure reference.

### SUMMARY OF THE INVENTION

Stated generally, the present invention comprises a sensor having a sensor housing defining a cavity therein. A first wall partially defining the cavity is deflectable under a physiologically relevant range of pressures. An integrated circuit chip bearing electronics is fixedly mounted within the cavity. A capacitor comprises first and second capacitor plates in generally parallel, spaced-apart relation. The first capacitor plate is physically coupled to the deflectable wall so as to move as the wall deflects, and the second capacitor plate is carried by the chip. The second capacitor plate is in electrical communication with the input pad of the chip.

Objects, features, and advantages of the present invention will become apparent upon reading the following specification, when taken in conjunction with the drawings and the appended claims.

### BRIEF DESCRIPTION OF THE DRAWINGS

FIG. 1 is a longitudinal cutaway view of a sensor according to a disclosed embodiment of the invention taken along line 1-1 of FIG. 2.

FIG. 2 is a transverse cutaway view along line 2-2 of FIG. 1.

FIGS. 3-11 are schematic views illustrating the disclosed process for manufacture of the sensor of FIG. 1.

FIG. 12 is an alternate embodiment of a sensor.

### DETAILED DESCRIPTION OF THE DISCLOSED EMBODIMENT

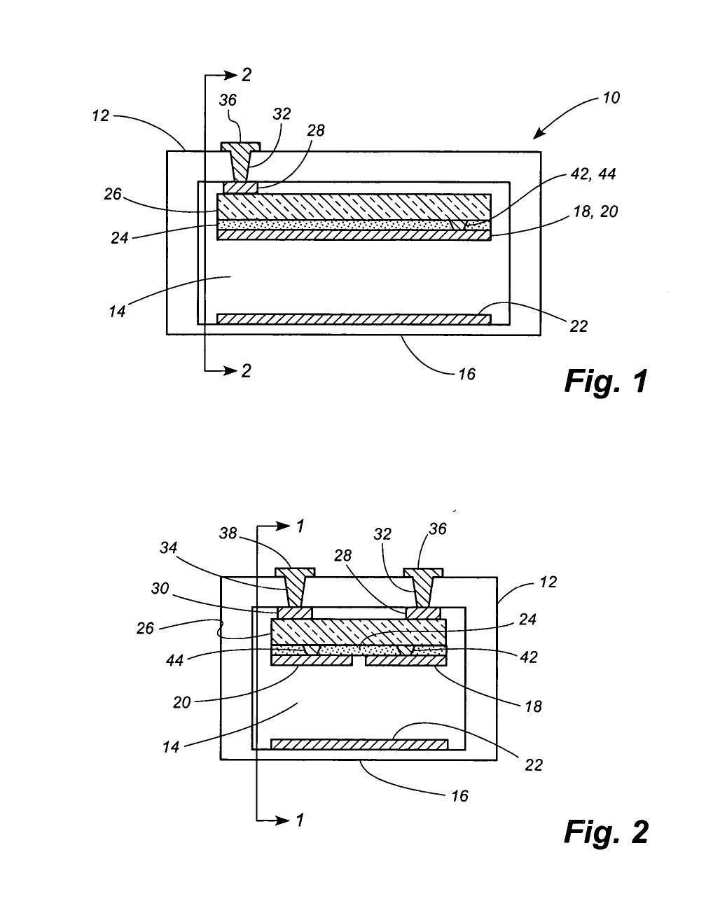

Referring now to the drawings, in which like numerals indicate like elements throughout the several views, FIG. 1 illustrates a sensor 10 adapted for implantation within the body of a patient. The sensor 10 includes a sensor body 12 defining an internal pressure chamber 14. One of the walls defining the pressure chamber 14 comprises a deflectable region 16 configured to deflect under a range of pressure physiologically relevant to the intended use. In a disclosed embodiment, a wall of the sensor body 12 is thinned relative to other walls of the sensor body to form the deflectable region 16.

In the disclosed embodiment, the sensor body 12 is formed using electrically insulating materials, particularly biocompatible ceramics, as substrate materials. Suitable ceramics include, for example, glass, fused silica, sapphire, quartz, or silicon. In the disclosed embodiment, fused silica is the substrate material. Various other methods for creating packaging incorporate other materials, and some involve joining dissimilar materials. The specific use of ceramic packaging in this example is not intended to be limiting, as many other methods for creating hermetic packaging are obvious to one skilled in the art.

An upper wall 17 of the pressure chamber 16 is generally parallel to and spaced apart from the deflectable region 16. A plurality of electrodes 28, 30, and optionally 40, are located on the upper wall 17. A silicon chip 26 bearing electronics is supported on the upper wall 17 by the electrodes 28, 30, 40. The silicon chip 26 has an insulating layer 24, e.g., silicon dioxide, disposed on its lower surface.

A pair of upper capacitor plates 18, 20 are affixed to the insulating layer 24 and thus carried by the silicon chip 26. A lower capacitor plate 22 is disposed on the deflectable region 16 of the pressure cavity 14 in parallel, spaced apart relation to the upper capacitor plates 18, 20. The two upper capacitor plates 18, 20 are electrically isolated from one another and are capacitively coupled through the lower capacitor plate 22. The upper capacitor plates 18, 20 and the lower capacitor plate 22 cooperate to form a gap capacitor having a characteristic capacitance value. As ambient pressure changes, the deflectable region 16 moves, displacing the lower capacitor plate 22 with respect to the upper capacitor plates 18, 20 and thereby changing the characteristic capacitance value of the capacitor.

The capacitor configuration depicted here in which the upper capacitor plate consists of two electrically isolated regions 18, 20 is but one example, and other configurations of a capacitor are possible and apparent to one skilled in the art.

Electrical feedthroughs 42, 44 are provided across the insulating layer 24 so that electrical communication can be established between the upper capacitor plates 18, 20 and the circuitry contained within the silicon chip 26. The feedthroughs 42, 44 are located so as to connect the upper capacitor plates 18, 20 to input pads on the silicon chip 26.

Electrodes 28, 30 are located on the upper wall 17 of the sensor body 12 and are in contact with output pads of the silicon chip 26. Electrical feedthroughs 32, 34 traverse the upper wall 17 of the sensor body 12. Electrical contact pads 36, 38 are formed on the exterior of the sensor body 12 in electrical communication with the feedthroughs 32, 34. The electrical contact pads 36, 38 provide a region on the exterior of the sensor 10 configured with sufficient dimensions so as to allow for a means for electrical connection with external electronics. Preferably the metal-fused silica interface between the electrodes 28, 30 and the interior surface of the pressure cavity body 12 is hermetic. The electrodes 28, 30 provide a means to fix the silicon chip 26 in the pressure chamber 14 and to establish electrical communication between the chip 26, internal circuitry, and the ambient via the electrical feedthroughs 32, 34.

The sensor configuration depicted above is merely an illustration of one implementation if the present invention. Any type of hermetic feedthrough and any type of packaging capable of creating a hermetic cavity can be used in this invention. Accordingly, packages created by the processes of eutectic or anodic bonding which utilize hermetic substrate materials to create the pressure cavity body 12 are all within the scope of this invention.

It is not necessary that this invention require electrical communication with external electronics to operate. For example, light can be used to power the sensor and/or receive information from the sensor.

Furthermore, it is not a limitation of this invention that the sensor require physical connection to external electronics in order to communicate with external electronics. This sensor may be configured so that wireless communication is provided for. As an example, an inductor coil can be provided as a means to supply power and receive information from the sensor.

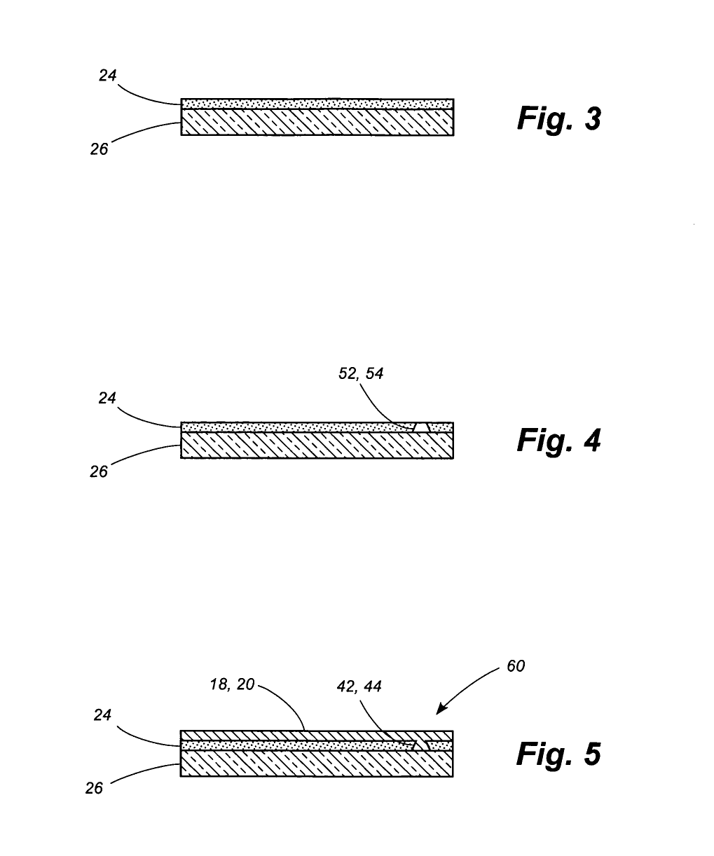

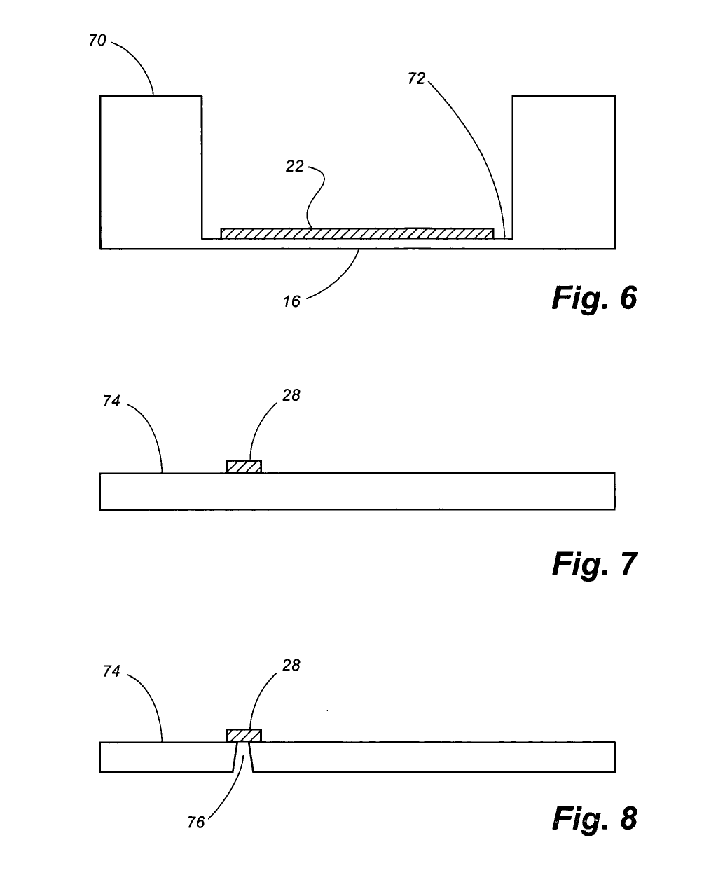

Fabrication of a sensor comprising a pressure cavity and a gap capacitor configured where at least one capacitor electrode is formed on the bare die of a silicon chip will now be explained with reference to FIGS. 3-11. Commonly owned U.S. patent applications Ser. Nos. 10/054,672; 10/886,829; 10/215,377; 10/215,379; 10/943,772; and 11/157,375; along with pending, commonly owned U.S. provisional patent application 60/656,868 are hereby incorporated by reference and provide examples of other possible sensor configurations that fall within the scope of this invention.

The preparation of the silicon chip will be explained on a per-chip basis for clarity and ease of illustration, but it should be understood that the following features are advantageously created in multiples over the surface of a wafer containing many such silicon chips.

As illustrated in FIG. 3, a wafer comprises silicon chips 26 having integrated circuits (ICs). A layer of electrically insulating material 24, e.g. silicon dioxide, is deposited on a surface of the chip 26. This can be accomplished by using plasma-enhanced chemical vapor deposition (PECVD) using a mixture of SiH₄ (2% in N₂) and NH₃ at 300 degrees C. Then, as shown in FIG. 4, the insulating layer 24 is selectively etched to remove material to expose parts of the underlying chip 26 where electrical communication can be established, thereby creating through holes 52, 54. This selective etching can be performed in any of a variety of ways, depending on the materials used in construction of the silicon chip. In one example where the circuitry of the silicon chip is comprised of gold, photolithography and buffer oxide etch (BOE) can be used to etch away the unwanted silicon dioxide.

Next, as illustrated in FIG. 5, a layer of conductive material, e.g., gold, is selectively deposited on top of the insulating material 24 in two electrically isolated regions to form the capacitor plates 18, 20. Each plate 18, 20 is deposited over a through hole 52, 54, and deposition material fills the through holes to form electrical feedthroughs that place each plate in electrical communication with a corresponding input pad on the chip 26. At this point the silicon chip assembly 60 is ready for incorporation into the sensor 10.

The manufacture of the sensor 10 depicted in FIG. 1 from the substrate (a.k.a. wafer) level is described in greater detail below. For clarity, the manufacture of the sensor is described on a single sensor basis, although multiple sensors are created simultaneously on the substrate in a batch fabrication process.

A lower substrate 70 is processed to create a recessed region 72. Creation of a recessed region with known geometry comprises the steps of (i) depositing and patterning a mask at the surface of the wafer, (ii) etching the wafer material through openings in the mask, and (iii) removing the mask.

One method for creating the desired recessed region 72 is described as follows: A thin metallic film is deposited at the surface of a fused silica substrate using a physical vapor deposition system (e.g., an electron-beam evaporator, filament evaporator, or plasma assisted sputterer). This thin film layer will form a mask used to create a recessed region in the upper surface of the lower substrate. The nature and thickness of the metal layer are chosen such that the mask is not altered or destroyed by the glass etchant. Next, photolithographic techniques are used to create a further mask to etch away the unwanted areas of the thin metal layer. Such unwanted areas of the thin metal layer define the perimeter of the recessed region. The unwanted metal is removed via use of selective etchants. Then a glass etchant is used to etch away the exposed fused silica to a desired depth, thereby creating the cavity (a.k.a. recessed region) and, further, the deflectable region.

The etched lower substrate 70 is now primed for creation of the metal electrode 22 at the bottom of the recess 72 atop the deflectable region 16. Following a similar process to that described above, a thin metal layer is deposited, and photolithographic techniques are used to mask the metal that will form the electrode 22. The unwanted metal and the remaining photolithographic material are then removed as previously described.

At this point, the lower substrate 70 comprises a recess 72 having a deflectable region 16 with an electrode 22 disposed thereon.

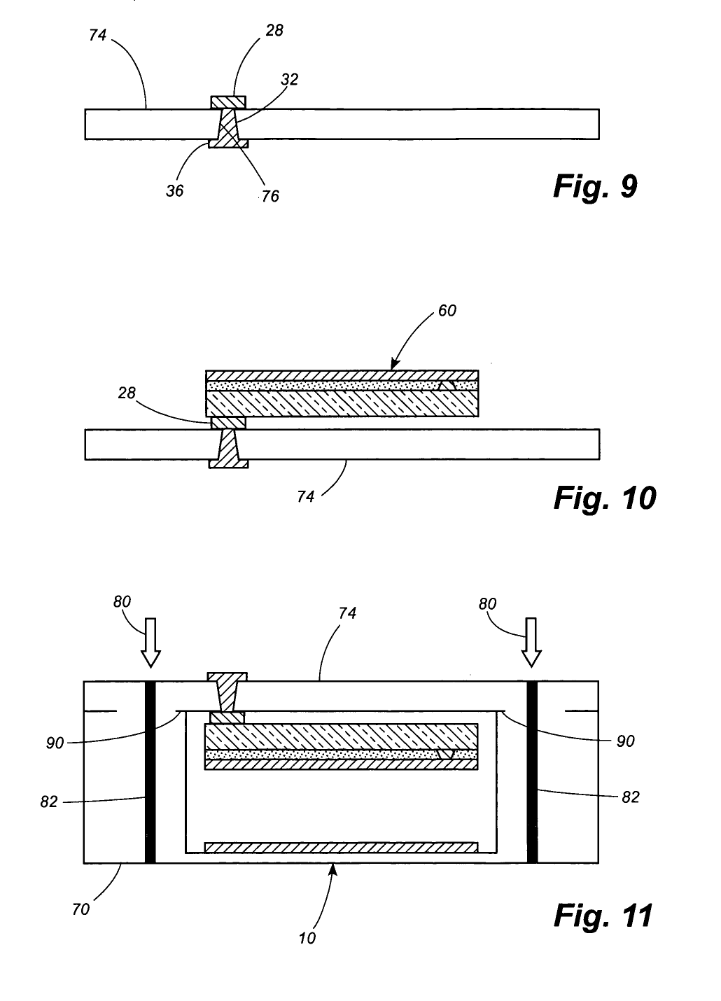

The upper substrate 74 that comprises the upper wall 17 of the pressure chamber 14 is created as follows. Referring first to FIG. 7, the conductive pads 28, 30 are deposited on the surface of the wafer 74 at predefined locations where electrical communication will later be established between the chip 26 and the exterior of the sensor body 12. Then, as shown in FIG. 8, using laser ablation or chemical etching or a combination of the two, material is selectively removed from the substrate 74 over the conductive pads 28, 30 to create through holes 76 that place the back side of the pads in communication with the ambient. Then, as shown in FIG. 9, the electrical contact pads 36, 38 are formed. In order to create the electrical contact pads 36, 38, any of a number of techniques can be used to deposit a layer of metal into the feedthrough cavity 76. The metal and deposition technique cannot be chosen independently of one another, but these combinations, along with their respective advantages and shortcomings, are known in the art. For the purposes of illustration, techniques such as low pressure plasma spray, electroplating or screen printing can be utilized to this end. Optionally, if compatible with the deposition technique chosen, the metal deposition is performed under a vacuum. If the feedthrough passage 76 is only partially filled with the electric contact pad 36, 38, the remainder of the passage can be filled with a ceramic material (e.g., glass frit) to further reinforce the feedthrough structure.

A variety of metal deposition techniques can be used (e.g., electroplating, use of molten metal, or PVD) depending on the choice of metal and desired material properties. In the case of a partially-filled feedthrough cavity, a void inside the feedthrough passage and above the electrical contact pad will remain. In order to fill this void and enhance the strength of the feedthrough, the remaining void can be filled with a ceramic material. Glass frit is one example of a ceramic material that can be used to fill the remaining space and heated sufficiently that the material flows, thereby eliminating any voids in the ceramic material. In the case of metal-filled feedthrough cavities, bonding pads on the exterior of the package are formed by, e.g., fusion bonding, low pressure plasma spray, laser welding, electroplating or PVD, depending on the choice of metal and the desired material properties. The electrical contact pads provide a site to connect to external electronics.

Suitable non-refractory metals for the electrical feedthroughs include gold, platinum, nickel, and silver. Suitable refractory metals include niobium, titanium, tungsten, tantalum, molybdenum, chromium, and a platinum/iridium alloy. If refractory metals are used to construct the feedthroughs, either alternating or direct current may be used to bias the sensors by external electronics. If any other metals are used, the sensors should be biased under AC power to prevent the onset of bias-induced corrosion.

Referring now to FIG. 10, the chip assembly 60 is bonded to the electrodes 28, 30 formed on the upper substrate 74 via flip chip technology known in the art.

Referring now to FIG. 11, the upper and lower substrates 70, 74 are fused together to create a hermetic sensor body 12, as follows. The upper and lower substrates 70, 74 are prepared for assembly, e.g., by cleaning. The two substrates 70, 74 are brought together and placed in intimate physical contact. A temporary bond is formed because of Van der Waals forces existing between the two substrates. A gap is maintained between the upper electrodes 18, 20 and the lower electrode 22 where the distance between the electrodes is precisely known. Using a CO₂ laser, indicated by the arrows 80, the sensor is reduced to its final dimensions. The laser cutting process also seamlessly fuses the upper and lower substrates 70, 74. In the disclosed embodiment, the laser operates at a peak wavelength of 10 micrometers.

With further reference to FIG. 11, the power of the CO₂ laser is controlled such that heat damage to the internal components is avoided. Consequently it is possible that some vestige of a seam 90 may remain between the upper and lower substrates 70, 74. So long as the outer periphery of the pressure cavity body 12 is completely fused, the interior chamber 14 will be hermetic.

The pressure cavity 14 is hermetic because of the following reasons. First, the pressure cavity body 12 is formed of a hermetic material and is a unitary structure, meaning there are no seams or bi-material joints that can form a potential path for gas or fluid intrusion into the pressure chamber other than the electric feedthroughs 32, 34, which are themselves hermetic. One reason for the hermeticity of the feedthroughs 32, 34 is that the electrodes 28, 30 are hermetically imposed onto the wall 68 over the feedthroughs. Optionally, the feedthroughs 32, 34 are themselves filled with a material capable of hermetic sealing, and the interface between the feedthrough material and the material defining the feedthrough passages is also hermetic. Thus gas or fluid would have to pass through or around the material in the feedthroughs 32, 34 and pass through or around the electrodes 18, 20 before it could enter the pressure chamber and compromise the integrity thereof. And finally, the feedthroughs 32, 34 are small, thereby minimizing the area of interface. Such feedthroughs interface with the pressure cavity body 12 at areas ranging from 10⁻⁶ to 10⁻⁹ square meters.

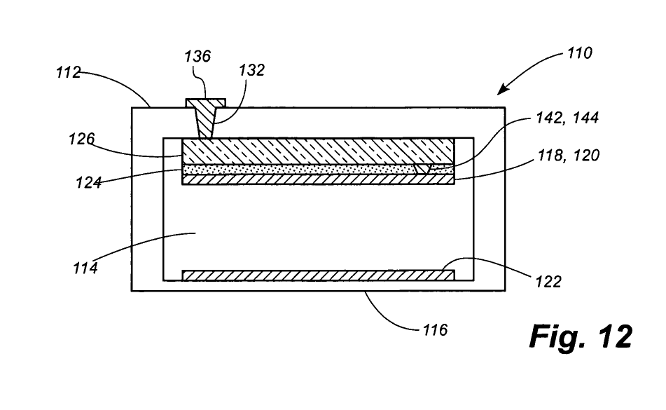

FIG. 12 illustrates an alternate embodiment of a sensor 110 comprising a sensor body 112, pressure chamber 114, deflectable region 116, and lower electrode plate 122. In this embodiment, however, the chip assembly 160 is mounted directly to the upper wall of the pressure chamber 114 by adhesive bonding or other suitable means. The electric feedthrough 132 is in direct electrical communication with an output pad of the IC chip.

The sensors 10, 110 can be fabricated using micro-machining techniques and are small, accurate, precise, durable, robust, biocompatible, and insensitive to changes in body chemistry or biology. Additionally, the sensors 10, 110 can incorporate radiopaque features to enable fluoroscopic visualization during placement within the body. While the invention has been illustrated in the context of a biological device, it will be appreciated that the silicon chip with integrated electrode herein described can be adapted to non-biological applications, for example, industrial applications in which a harsh environment is encountered.

Finally, it will be understood that the preferred embodiment has been disclosed by way of example, and that other modifications may occur to those skilled in the art without departing from the scope and spirit of the appended claims.

What is claimed is:

1. A sensor comprising:
a sensor housing defining a cavity therein, said housing comprising a first wall partially defining said cavity that is deflectable under a physiologically relevant range of pressures;
an integrated circuit chip bearing electronics, said chip being fixedly mounted within said cavity, and said chip having input and output pads;
a capacitor comprising first and second capacitor plates in generally parallel, spaced-apart relation, said first capacitor plate being physically coupled to said deflectable wall so as to move as said wall deflects, and said second capacitor plate being carried by said chip; and
means for placing said second capacitor plate in electrical communication with said input pad of said chip.

2. The sensor of claim 1,
wherein said housing comprises a second wall defining said cavity, said second wall being generally parallel to and spaced apart from said first wall; and
wherein said chip being fixedly mounted within said cavity comprises said chip being mounted to said second wall.

3. The sensor of claim 2, further comprising a first electrical contact pad affixed to said second wall and in electrical communication with said output pad of said chip, wherein said chip is mounted to said second wall by said electrical contact pad.

4. The sensor of claim 3, further comprising a second electrical contact pad affixed to said second wall for mounting said chip to said second wall.

5. The sensor of claim 3, further comprising an electrical feedthrough extending from the cavity of said housing to the exterior of said housing and in electrical communication with said first electrical contact pad so as to allow electrical communication between said output pad of said chip and the exterior of said housing.

6. The sensor of claim 5, wherein said electrical feedthrough extends through said second wall.

7. The sensor of claim 1, wherein said housing is hermetic.

8. The sensor of claim 5, wherein said electrical feedthrough is hermetic.

9. The sensor of claim 1, wherein said second capacitor plate being carried by said chip comprises a layer of an insulating material being located on a surface of said chip facing said first capacitor plate, and said second capacitor plate being mounted to said layer of insulating material.

10. The sensor of claim 1, further comprising a third capacitor plate, said third capacitor plate being located generally co-planar with said second capacitor plate and spaced-apart therefrom, said third capacitor plate being carried by said chip, and said second and third capacitor plates being capacitively coupled to one another via said first capacitor plate.

11. The sensor of claim 10, wherein said chip further comprises a second input pad, and wherein said sensor further comprises means for placing said third capacitor plate in electrical communication with said second input pad of said chip.

12. The sensor of claim 10, wherein said second and third capacitor plates being carried by said chip comprises a layer of an insulating material being located on a surface of said chip facing said first capacitor plate, and said second and third capacitor plates being mounted to said layer of insulating material.

13. The sensor of claim 2, wherein said chip being mounted to said second wall comprises said chip being adhesively bonded to said second wall.
